(19) United States
(12) Patent Application Publication
(10) Pub. No.: US 2017/0109092 A1
(43) Pub. Date: Apr. 20, 2017

(54) SELECTIVE INITIALIZATION OF STORAGE DEVICES FOR A LOGICAL VOLUME

(71) Applicant: Avago Technologies General IP (Singapore) Pte. Ltd., Singapore (SG)

(72) Inventor: Atsushi Yoshioka, San Francisco, CA (US)

(21) Appl. No.: 14/883,799

(22) Filed: Oct. 15, 2015

(51) Int. Cl. G06F 3/06

(52) U.S. Cl. CPC G06F 3/0632; G06F 3/0607; G06F 3/0689

(57) ABSTRACT

Methods and structure for initializing storage devices for a logical volume. One embodiment includes a storage controller with an interface and a control unit. The control unit generates a logical volume, assigns storage devices to the logical volume, generates Small Computer System Interface (SCSI) MODE SENSE commands, and transmits the SCSI MODE SENSE commands via the interface, thereby accessing SCSI mode pages. The control unit also analyzes the SCSI mode pages to determine whether the assigned storage devices have already been initialized by setting available bits in the logical volume to a uniform value. If the control unit determines that each of the assigned storage devices has not already been initialized, the control unit initializes at least one of the assigned storage devices. If the control unit determines that each of the assigned storage devices has already been initialized, the control unit foregoes initialization for the storage devices.

### FIELD

The invention relates generally to storage systems, and more specifically to logical volumes implemented by storage systems.

### BACKGROUND

Logical volumes, such as Redundant Array of Independent Disks (RAID) volumes, are implemented by storage devices that persistently store volume data. When a logical volume is first configured/created, the storage devices assigned to the logical volume are initialized, by writing a zero value to each available bit in the storage devices. However, initialization is a time consuming and processing intensive task that can take hours, particularly when large storage devices are used. Furthermore, even when initialization occurs as a background process, it can occupy valuable computing resources for a storage system.

### BRIEF DESCRIPTION OF THE DRAWINGS

Some embodiments of the present invention are now described, by way of example only, and with reference to the accompanying figures. The same reference number represents the same element or the same type of element on all figures.

FIG. 1 is a block diagram of an exemplary storage system.

FIG. 2 is a block diagram of an exemplary storage controller of a storage system.

FIG. 3 is a block diagram of an exemplary storage device of a storage system.

FIG. 4 is a flowchart describing an exemplary method to operate a storage controller of a storage system.

FIG. 5 is a message diagram illustrating exemplary communications between elements of a storage system.

FIGS. 6-7 are tables illustrating an exemplary SCSI MODE PAGE and an exemplary SCSI MODE SENSE command.

FIG. 8 illustrates an exemplary processing system operable to execute programmed instructions embodied on a computer readable medium.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

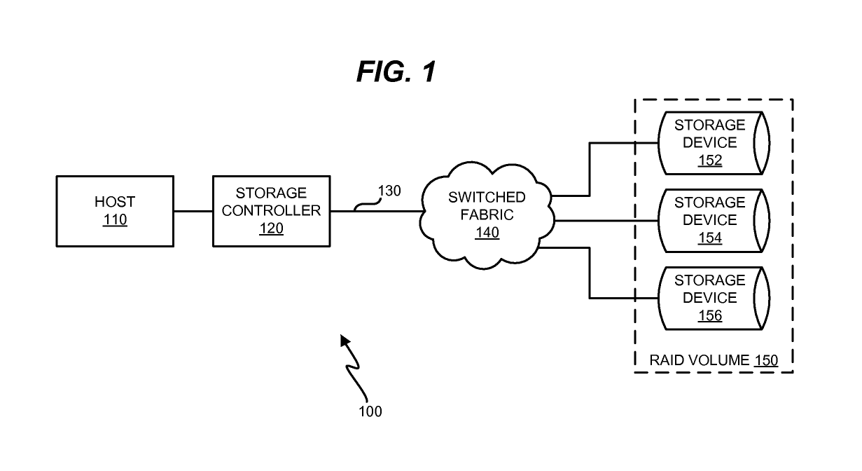

FIG. 1 is a block diagram of an exemplary storage system 100. Storage system 100 retrieves and stores data based on Input/Output (I/O) requests originated by host 110. For example, in this embodiment storage system 100 utilizes storage devices 152, 154, and 156 to implement Redundant Array of Independent Disks (RAID) volume 150. Host 110 provides I/O requests to storage controller 120, which processes the I/O requests and exchanges communications with storage devices 152, 154, and/or 156 via switched fabric 140 in order to retrieve or store data.

Storage system 100 is capable of determining whether a set of storage devices has already been initialized when it creates a logical volume. Based on this information, storage system 100 selectively foregoes initialization for disks of the logical volume. This saves the substantial processing burden of overwriting each available bit in a storage device to a uniform value. Storage system 100 is capable of determining whether or not a storage device has been pre-initialized in this manner by reviewing custom Small Computer System Interface (SCSI) MODE PAGE information for the storage device.

Host 110 comprises any system capable of performing processing operations upon stored data. Host 110 is communicatively coupled with storage devices 152, 154, and 156 via storage controller 120, and can provide host I/O requests (e.g. sourced by an Operating System (OS) of host 110) to storage controller 120. Host I/O requests directed to a logical volume include requests to provide data from the logical volume to a host as well as requests to modify written data at the logical volume.

Storage controller 120 comprises any system, component, or device operable to translate host I/O requests into communications directed to one or more storage devices. That is, storage controller 120 may receive an I/O request from host 110 that is directed to one or more Logical Block Addresses (LBAs) at RAID volume 150, and translate that request into communications directed to the storage device(s) that maintain data for those requested LBAs. These communications are generated via any suitable communication protocol for storage systems, and are transmitted via communication channel 130. Communication channel 130 is implemented for example as an interface for SCSI, Serial Attached SCSI (SAS), Peripheral Component Interconnect Express (PCIe), etc.

Switched fabric 140 comprises any suitable combination of communication channels and devices operable to forward/route communications between the various interconnected devices of storage system 100. In one embodiment, switched fabric 140 comprises a combination of expanders/switches that are themselves coupled with storage devices. For example, in one embodiment an expander/switch of switched fabric 140 communicatively couples storage devices 152, 154, and 156 to storage controller 120.

Storage devices 152, 154, and 156 implement the persistent storage capacity of storage system 100, and are capable of writing and/or reading data in a computer readable format. For example, the storage devices can comprise magnetic hard disks, solid state drives, optical media, etc. compliant with protocols for SAS, Serial Advanced Technology Attachment (SATA), Fibre Channel, etc. The storage devices implement storage space for one or more logical volumes. A logical volume comprises allocated storage space and data available at storage system 100. A logical volume can be implemented on any number of storage devices as a matter of design choice. Furthermore, the storage devices need not be dedicated to only one logical volume, but can also store data for a number of other logical volumes.

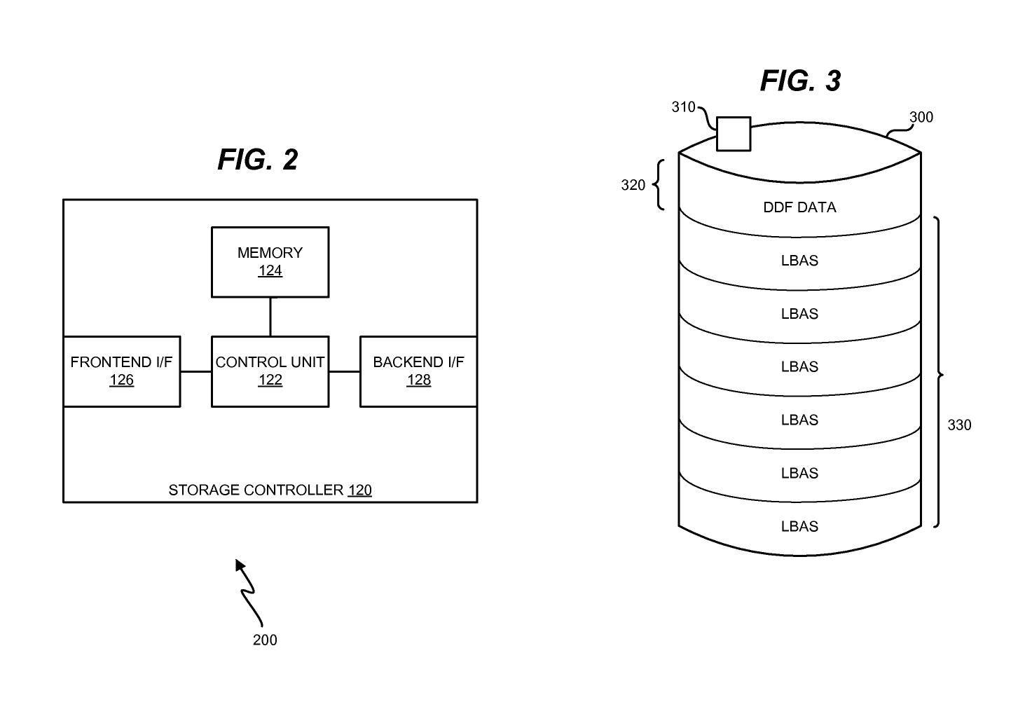

FIG. 2 illustrates further details of storage controller 120. Specifically, FIG. 2 illustrates that storage controller 120 includes control unit 122, memory 124, frontend interface 126, and backend interface 128. Control unit 122 manages the operations of storage controller 120, such as the generation of new logical volumes, the generation of commands directed to storage devices, etc. Control unit 122 also actively determines whether a storage device has already been initialized or not. Control unit 122 is implemented as custom circuitry, a processor executing programmed instructions stored in program memory, or some combination thereof. Memory 124 stores data for reference by control unit 122, such as program instructions for control unit 122, data structures that correlate LBAs with storage devices, volume information data, routing information, etc. In this embodiment memory 124 is implemented as a non-volatile, high speed storage device such as a Non-Volatile Random Access Memory (NVRAM), a flash Solid State Drive (SSD), etc. Frontend interface 126 transmits communications between host 110 and storage controller 120. In embodiments where storage controller 120 is implemented as a Host Bus Adapter (HBA), frontend interface 126 comprises a bus interface such as a PCIe interface. Backend interface 128 transmits communications between storage controller 120 and storage devices 152, 154, and 156. Backend interface 128 is compatible with the communication protocol supported by communication channel 130.

FIG. 3 is a block diagram depicting the contents of an exemplary storage device 300. In this embodiment, storage device 300 includes device configuration space 310, such as a separate flash memory component embedded/integrated in storage device 300 for the purpose of storing device configuration data (not volume data). In this embodiment, device configuration space 310 includes SCSI MODE PAGES identifying the SCSI capabilities of storage device 300. Space 310 is not available for use storing data for a logical volume, and is not overwritten during the initialization process. In short, space 310 is unavailable space at storage device 300.

Storage device 300 also includes space that is available for use to persistently store data. This space, represented by section 320, includes space for volume configuration data (e.g., Disk Data Format (DDF) data for a logical volume) provided by a storage controller. Section 320 is reserved by a storage controller for use in maintaining the logical volume, and therefore is not available to a host utilizing the volume. Section 330, which persistently stores volume data for the host, is available for access by a host.

In one embodiment, when initialization processes are performed upon storage device 300 to overwrite the bits of storage device 300, the initialization process does not overwrite device configuration space 310. This is because space 310 represents configuration data, for the storage device itself, that is not available for persistent storage of logical volume data, and overwriting space 310 would potentially cause a storage device to become unresponsive (e.g., unresponsive to SCSI devices requesting that configuration information). Furthermore, in some embodiments, initialization does not overwrite section 320. This is because section 320 represents configuration data for the volume, which is also not available to store data for the logical volume (e.g., “payload” data).

The particular arrangement, number, and configuration of components described herein is exemplary and non-limiting. While in operation, storage system 100 is operable to retrieve and store data on behalf of host 110.

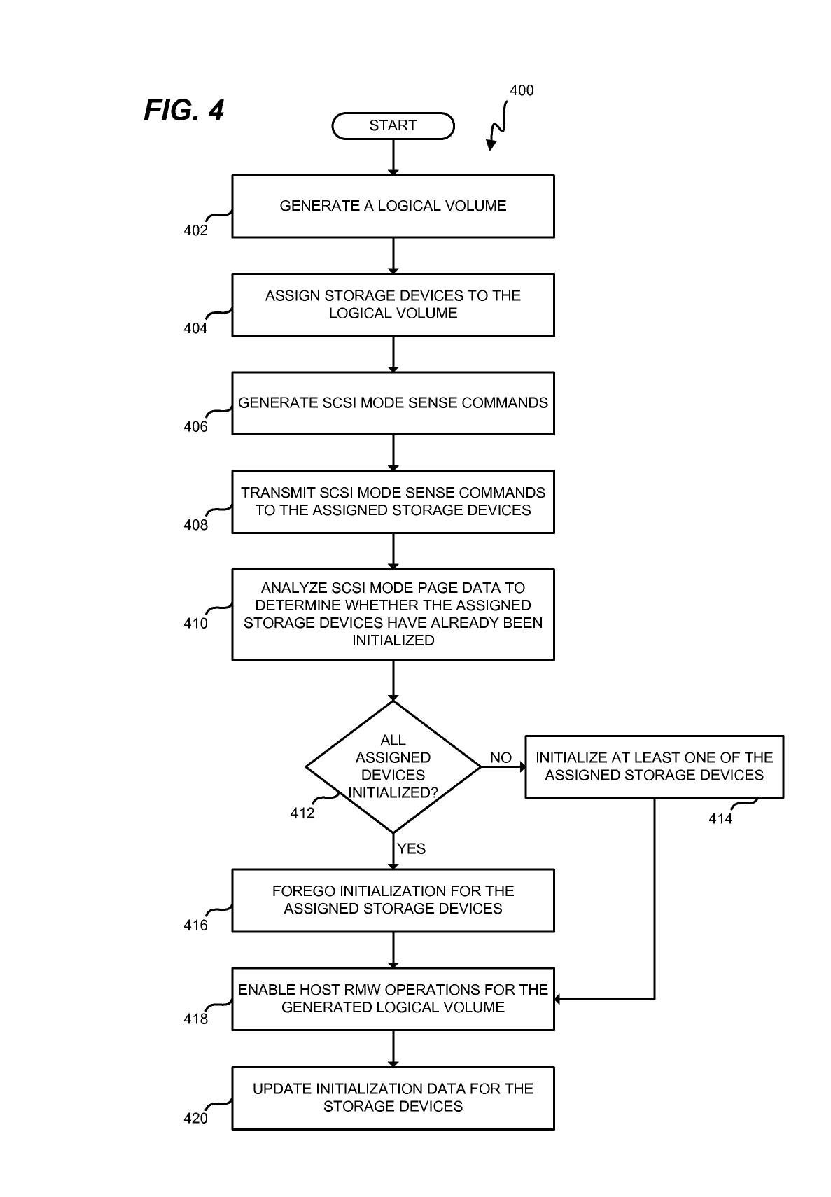

FIG. 4 is a flowchart describing an exemplary method 400 for operating storage system 100 to selectively forego initialization for storage devices. In step 402, control unit 122 of storage controller 120 generates a logical volume. In this embodiment, the act of generating a logical volume includes receiving a request from host 110 requesting the creation of a logical volume. The request can indicate a preferred size of the logical volume, from which control unit 122 may select an appropriate set of storage devices, or the request can explicitly select storage devices to implement the logical volume. In this embodiment, the request also specifies a RAID level to implement for the logical volume, and indicates whether Read-Modify-Write (RMW) operations should be enabled for the logical volume. RMW operations enhance the speed of processing for a logical volume, but many logical volumes require assurance that volume data is consistent (e.g., that storage devices for the logical volume have been initialized, resulting in consistent data) before RMW can be successfully implemented.

Based on this information, control unit 122 assigns storage devices to the logical volume in step 404, and updates volume configuration information (e.g., RAID configuration information) in memory 124 in order to represent the new logical volume. At this point in time, because the logical volume has been created but not fully initialized, access by host 110 to the new logical volume is prevented by storage controller 120 (e.g., by not yet sending a confirmation to host 110 indicating that the volume is ready for I/O requests).

After the storage devices for the logical volume have been selected/assigned, control unit 122 generates SCSI MODE SENSE commands in step 406 that are directed to a vendor-specific SCSI MODE PAGE for each of the assigned storage devices. Backend interface 128 transmits the SCSI MODE SENSE commands to the assigned storage devices in step 408 via switched fabric 140. In response to these requests, the assigned storage devices each provide data from the requested vendor specific SCSI MODE PAGE. This data includes a flag indicating whether the storage device has already been initialized by having its bits set uniformly to one value (e.g., all zero, or all one). The flag provided in each storage device may have been previously set, for example, by a manufacturer of the storage device as a bit of a vendor-unique SCSI MODE PAGE.

In step 410, control unit 122 analyzes the retrieved SCSI MODE PAGE data to determine whether the assigned storage devices have already been initialized. Thus, control unit 122 consults the retrieved data to determine whether or not the initialization flag has been set for each storage device. If in step 412 all storage devices for the requested logical volume have been initialized, then in step 416 control unit 122 foregoes initialization, even if RMW operations should be enabled for the logical volume. This is because the storage devices, having all been initialized, are also consistent in that their parity data properly represents their “payload” data. Alternatively, if not all of the storage devices have been initialized, then control unit 122 of storage controller 120 begins the laborious process of initializing the storage devices by overwriting their available storage space to a uniform value (e.g., zero or one) in step 414. This initialization is either performed as a background process during which I/O requests to the volume are enabled (but RMW operations are not enabled), or is performed as an active process wherein host I/O directed to the logical volume is disabled. In one embodiment, SCSI MODE PAGES are not altered by the act of initializing a storage device.

In one embodiment the process is performed on a storage device by storage device basis, depending on whether the storage device has already been initialized or not. Control unit 122 then foregoes RMW operations on the logical volume until after initialization has been completed for all of the assigned storage devices for the logical volume. After all storage devices have been initialized (or have been determined to already have been initialized) controller 120 updates memory 124 to indicate that the logical volume is consistent such that parity data in the logical volume correctly corresponds with/matches/confirms “payload” data in the logical volume. Controller 120 enables RMW operations directed to the logical volume in step 418. Furthermore, controller 120 may update initialization data for each storage device (e.g., by transmitting a SCSI MODE SELECT command to alter SCSI MODE PAGE data) in order to indicate that these storage devices, which are now being filled with volume data, are no longer in an initialized state, in step 420. Updating/altering an initialization flag in a SCSI MODE PAGE ensures that a storage device which is no longer initialized does not appear as initialized to controller 120. Thus, storage controller 120 saves a substantial amount of time when creating the new logical volume, because storage controller 120 does not need to initialize each storage device in order to ensure a consistent logical volume and enable RMW operations for that logical volume.

Even though the steps of method 400 are described with reference to storage system 100 of FIG. 1, method 400 can be performed in other storage systems exhibiting different configurations. The steps of the flowcharts described herein are not all inclusive and can include other steps not shown. The steps described herein can also be performed in an alternative order.

In a further embodiment, in response to enabling host I/O directed to the new logical volume, control unit 122 transmits a command (e.g., SCSI MODE SELECT) to one or more of the storage devices in order to alter SCSI MODE PAGE data. Specifically, any storage devices that were already initialized have their flag set to indicate that they are no longer initialized. In this manner, if the storage device (which is now being written to and modified, and has therefore become uninitialized) is ever assigned to a new logical volume, storage controller 120 will not mistake the storage device for an initialized storage device. Alternatively, storage controller 120 updates data in memory 124 without altering the SCSI MODE PAGES of the storage devices, in order to flag the storage devices implementing the volume as uninitialized storage devices. This reduces I/O traffic across switched fabric 140.

In a still further embodiment, if storage devices are dropped from the new logical volume, or the new logical volume is deleted, then control unit 122 begins initialization for the storage devices (e.g., during an idle or low-traffic period for storage system 100, such as late at night), even though the storage devices are not presently requested for use in any logical volumes. Control unit 122 then either sets SCSI MODE PAGE flags for the storage devices to indicate that the storage devices have again been initialized, or updates memory 124 to indicate this change in status. In this manner, when the storage devices are requested for use in a new logical volume, initialization procedures can be foregone for those storage devices.

In a further embodiment, storage controller 120 acquires the SCSI MODE PAGE data from each storage device at start-of-day, and maintains data in memory 124 indicating whether each storage device has already been initialized or not. Control unit 122 can further selectively choose storage devices to use for a logical volume, based on the capacity of those storage devices and/or whether memory 124 indicates that the storage devices have already been initialized.

### Examples

In the following examples, additional processes, systems, and methods are described in the context of a storage system that generates a new logical volume.

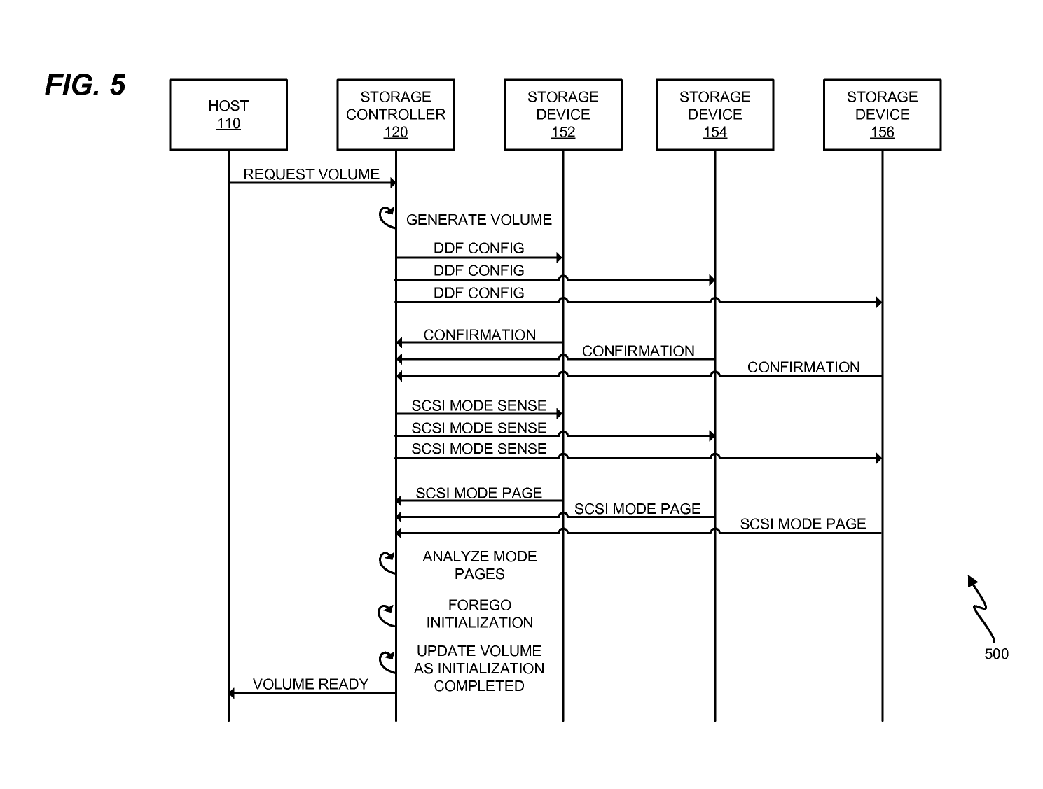

FIG. 5 is a message diagram 500 illustrating exemplary communications between elements of storage system 100. In this example, host 110 initiates the process by requesting the creation of a RAID volume with a capacity of 150 gigabytes (GB) via a PCIe request. The host request also requests enhanced levels of RAID performance associated with RMW operations. Storage controller 120 receives the PCIe request, and determines that storage devices 152, 154, and 156 implement enough storage space to redundantly store 150 GB of data. Hence, storage controller 120 generates a logical volume by assigning storage devices 152, 154, and 156 to the requested RAID volume, and updating memory 124 to reflect this change. Next, control unit 122 generates commands that provide DDF configuration data to each storage device, and receives a confirmation from each storage device indicating that the DDF configuration data has been successfully stored. Control unit 122 then generates SCSI MODE SENSE commands directed to each storage device (152, 154, 156). Each storage device, in response to receiving the SCSI MODE SENSE COMMAND, identifies corresponding vendor-specific SCSI MODE PAGE data, and transmits that SCSI MODE PAGE data back to storage controller 120. Storage controller 120 analyzes the SCSI MODE PAGE data that has been retrieved, and determines that all of the storage devices have already been pre-initialized. Based on this information, storage controller 120 foregoes initialization for all of the storage devices, and transmits an acknowledgment to the host indicating that I/O requests to the volume (including I/O requests that involve RMW operations) are enabled. As host 110 writes to the logical volume, storage controller 120 transmits SCSI MODE SELECT commands to the storage devices, to alter their initialization flags and indicate that the storage devices are no longer in an initialized state.

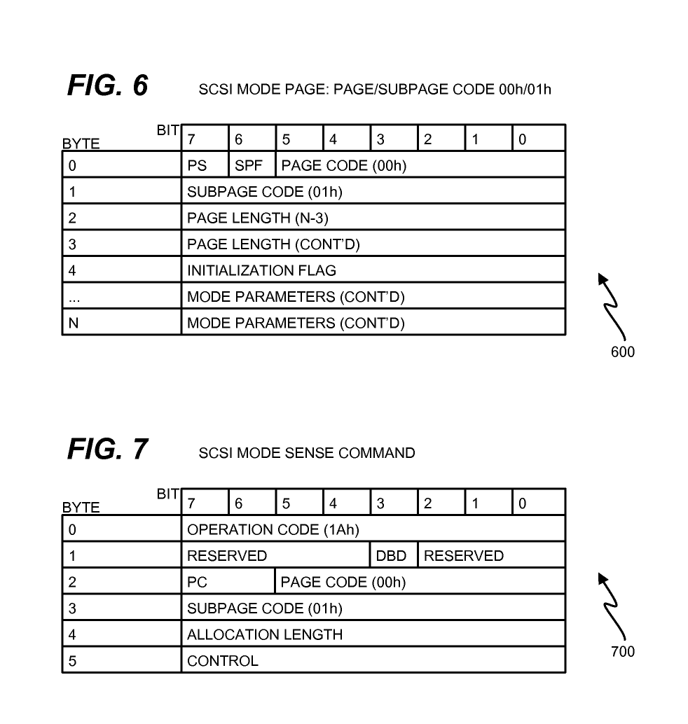

FIGS. 6-7 are tables illustrating an exemplary SCSI MODE PAGE and an exemplary SCSI MODE SENSE command. Specifically, FIG. 6 illustrates an exemplary vendor specific SCSI MODE PAGE 600 that includes a reserved byte for an initialization flag. The flag therefore indicates not just whether or not initialization was performed, but can further indicate whether a specific type of initialization was performed (initialized to zero's, initialized to one's), a time/date of the initialization, whether initialization is currently in progress, and whether the initialization was performed by the manufacturer or by a storage controller. FIG. 7 illustrates an exemplary SCSI MODE SENSE command 700 directed to the vendor specific SCSI MODE PAGE. The page code and subpage code of the SCSI MODE SENSE command correspond with the page and subpage of the vendor-specific SCSI MODE PAGE.

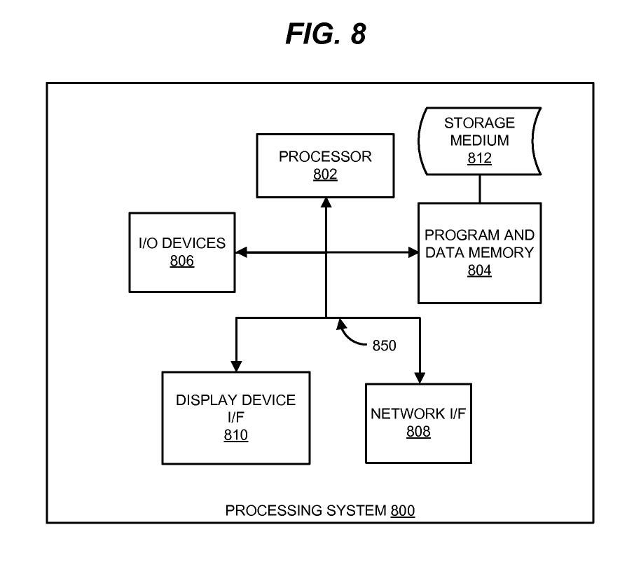

Embodiments disclosed herein can take the form of software, hardware, firmware, or various combinations thereof. In one particular embodiment, software is used to direct a processing system of a storage controller to perform the various operations disclosed herein. FIG. 8 illustrates an exemplary processing system 800 operable to execute a computer readable medium embodying programmed instructions. Processing system 800 is operable to perform the above operations by executing programmed instructions tangibly embodied on computer readable storage medium 812. In this regard, embodiments of the invention can take the form of a computer program accessible via computer readable medium 812 providing program code for use by a computer (e.g., processing system 800) or any other instruction execution system. For the purposes of this description, computer readable storage medium 812 can be anything that can contain or store the program for use by the computer (e.g., processing system 800).

Computer readable storage medium 812 can be an electronic, magnetic, optical, electromagnetic, infrared, or semiconductor device. Examples of computer readable storage medium 812 include a solid state memory, a magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD.

Processing system 800, being used for storing and/or executing the program code, includes at least one processor 802 coupled to program and data memory 804 through a system bus 850. Program and data memory 804 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 806 (including but not limited to keyboards, displays, pointing devices, etc.) can be coupled either directly or through intervening I/O controllers. Network adapter interfaces 808 can also be integrated with the system to enable processing system 800 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 810 can be integrated with the system to interface to one or more display devices, such as printing systems and screens for presentation of data generated by processor 802.

What is claimed is:

1. A storage controller, comprising:
an interface operable to communicate with coupled storage devices; and
a control unit operable to generate a logical volume, to assign storage devices to the logical volume, to generate Small Computer System Interface (SCSI) MODE SENSE commands, and to transmit the SCSI MODE SENSE commands via the interface, thereby accessing SCSI mode pages of the assigned storage devices,
wherein the control unit is further operable to analyze the SCSI mode pages to determine whether the assigned storage devices have already been initialized by setting available bits in the logical volume to a uniform value, and:
if the control unit determines that each of the assigned storage devices has not already been initialized, the control unit is operable to initialize at least one of the assigned storage devices; and
if the control unit determines that each of the assigned storage devices has already been initialized, the control unit is operable to forego initialization for the assigned storage devices.

2. The storage controller of claim 1, wherein:
the control unit is further operable to read a flag at a SCSI mode page indicating whether a corresponding storage device has already been initialized.

3. The storage controller 2, wherein:
the SCSI mode page is a vendor unique page, and the flag comprises a bit on the vendor unique page.

4. The storage controller of claim 1, wherein:
the control unit is further operable to perform Read-Modify-Write (RMW) operations on the logical volume, in response to foregoing initialization for the assigned storage devices.

5. The storage controller of claim 1, wherein:
the control unit is further operable to selectively forego initialization on a storage device by storage device basis.

6. The storage controller of claim 1, further comprising:
a memory storing configuration data for the logical volume,
wherein the control unit is further operable to update the memory with information indicating whether each of the assigned storage devices for the logical volume has been initialized.

7. The storage controller of claim 1, wherein:
the control unit is further operable to forego Read-Modify-Write (RMW) operations on the logical volume until after initialization has been completed for all of the assigned storage devices, in response to initializing at least one of the assigned storage devices.

8. A method for operating a storage controller, comprising:
generating a logical volume;
assigning storage devices to the logical volume;
generating Small Computer System Interface (SCSI) MODE SENSE commands;
transmitting the SCSI MODE SENSE commands to the assigned storage devices, thereby accessing SCSI mode pages of the assigned storage devices; and
analyzing the SCSI mode pages to determine whether the assigned storage devices have already been initialized by setting available bits in the logical volume to a uniform value, wherein:
if each of the assigned storage devices has not already been initialized, the method further comprises initializing at least one of the assigned storage devices; and
if each of the assigned storage devices has already been initialized, the method further comprises foregoing initialization for the assigned storage devices.

9. The method of claim 8, wherein
analyzing the SCSI mode pages comprises reading a flag at a SCSI mode page indicating whether a corresponding storage device has already been initialized.

10. The method of claim 9, wherein:
the SCSI mode page is a vendor unique page, and the flag comprises a bit on the vendor unique page.

11. The method of claim 8, further comprising:
performing Read-Modify-Write (RMW) operations on the logical volume, in response to foregoing initialization for the assigned storage devices.

12. The method of claim 8, further comprising:
selectively foregoing initialization on a storage device by storage device basis.

13. The method of claim 8, further comprising:
updating a memory of the storage controller with information indicating whether each of the assigned storage devices for the logical volume has been initialized.

14. The method of claim 8, further comprising:
foregoing Read-Modify-Write (RMW) operations on the logical volume until after initialization has been completed for all of the assigned storage devices, in response to initializing at least one of the assigned storage devices.

15. A non-transitory computer readable medium embodying programmed instructions which, when executed by a processor, are operable for directing the processor to:
generate a logical volume;
assign storage devices to the logical volume;
generate Small Computer System Interface (SCSI) MODE SENSE commands;
transmit the SCSI MODE SENSE commands to the assigned storage devices, thereby accessing SCSI mode pages of the assigned storage devices; and
analyze the SCSI mode pages to determine whether the assigned storage devices have already been initialized by setting setting available bits in the logical volume to a uniform value, wherein:
if each of the assigned storage devices has not already been initialized, the method further comprises initialize at least one of the assigned storage devices; and
if each of the assigned storage devices has already been initialized, the method further comprises forego initialization for the assigned storage devices.

16. The medium of claim 15, wherein the instructions further direct the processor to:
analyze the SCSI mode pages comprises reading a flag at a SCSI mode page indicating whether a corresponding storage device has already been initialized.

17. The method of claim 16, wherein:
the SCSI mode page is a vendor unique page, and the flag comprises a bit on the vendor unique page.

18. The method of claim 15, wherein the instructions further direct the processor to:
perform Read-Modify-Write (RMW) operations on the logical volume, in response to foregoing initialization for the assigned storage devices.

19. The method of claim 15, wherein the instructions further direct the processor to:
selectively forego initialization on a storage device by storage device basis.

20. The method of claim 15, wherein the instructions further direct the processor to:
update a memory of the storage controller with information indicating whether each of the assigned storage devices for the logical volume has been initialized.
